(19) United States
(12) Patent Application Publication
(10) Pub. No.: US 2025/0196653 A1
(43) Pub. Date: Jun. 19, 2025

(54) ELECTRICAL CIRCUIT AND STORAGE MEDIUM

(71) Applicant: TOYOTA JIDOSHA KABUSHIKI KAISHA, Toyota-shi (JP)

(72) Inventors: Shingo YUMOTO, Nisshin-shi (JP); Jinwoo KIM, Nisshin-shi (JP)

(73) Assignee: TOYOTA JIDOSHA KABUSHIKI KAISHA, Toyota-shi (JP)

(21) Appl. No.: 18/810,698

(22) Filed: Aug. 21, 2024

(30) Foreign Application Priority Data
Dec. 19, 2023 (JP) 2023-213784

(51) Int. Cl. B60L 15/00; B60L 50/60; B60L 58/19; H01M 10/42; H02P 27/06

(52) U.S. Cl. CPC B60L 15/007; B60L 50/60; B60L 58/19; H01M 10/425; H02P 27/06; H01M 2010/4271

(57) ABSTRACT

The electrical circuit mounted on the vehicle includes a first battery, a second battery, a three-phase motor, an inverter circuit, a port, and a control circuit. When external electrical equipment is connected to the port, the control circuit performs an output voltage adjustment process when it is determined that an output voltage of the second battery is higher than an output voltage of the first battery.

### CROSS-REFERENCE TO RELATED APPLICATION

This application claims priority to Japanese Patent Application No. 2023-213784 filed on Dec. 19, 2023, incorporated herein by reference in its entirety.

### BACKGROUND

### 1. Technical Field

The technique disclosed in the present specification relates to electrical circuits and a storage medium.

### 2. Description of Related Art

Japanese Unexamined Patent Application Publication No. 2020-120566 (JP 2020-120566 A) discloses an electrical circuit mounted on a vehicle. This electrical circuit includes a series circuit of two batteries, an inverter circuit, and a three-phase motor. The inverter circuit drives the three-phase motor by converting direct current (DC) power supplied from the series circuit of the batteries to alternating current (AC) power and supplying the AC power to the three-phase motor. This electrical circuit also includes a wire that connects a connection point of the two batteries and a neutral point of coils of the three-phase motor. The temperature of each battery can be increased by transferring electric power between the two batteries via this wire.

### SUMMARY

For an electrical circuit that includes a first battery, a second battery, an inverter circuit, and a three-phase motor, there is a technique of transferring electric power between each battery and electrical equipment located outside a vehicle. The first battery is connected to the electrical equipment via a wire. The second battery is connected to the electrical equipment via the inverter circuit and the three-phase motor. With this configuration, the two batteries can be connected in parallel with the external electrical equipment. In the case where the output voltage of the second battery is higher than the output voltage of the first battery in this type of electrical circuit, a current may flow from the second battery to the first battery via a diode in the inverter circuit when the first battery and the second battery are connected in parallel (hereinafter this current will be referred to as “leakage current”). Such a leakage current degrades the first battery and the second battery. The present specification proposes a technique of adjusting the output voltage of a battery.

An electrical circuit disclosed in the present specification is mounted on a vehicle. The electrical circuit includes:
a first battery;
a second battery;
a three-phase motor;
an inverter circuit;
a port; and
a control circuit.
   The three-phase motor includes three windings that are a U-phase winding, a V-phase winding, and a W-phase winding. Each of the three windings includes a first connection terminal provided at one end of the winding, and a second connection terminal provided at the other end of the winding. The second connection terminals of the three windings are connected to each other at a neutral point.
   The inverter circuit is connected to the first connection terminal of the U-phase winding, the first connection terminal of the V-phase winding, and the first connection terminal of the W-phase winding.
   The port includes a high potential connection terminal and a low potential connection terminal. The inverter circuit includes a high potential wire, a low potential wire, and three series switch circuits provided for each of the three windings. Each of the series switch circuits includes an upper reverse conduction switching element and a lower reverse conduction switching element, the upper reverse conduction switching element being a reverse conduction switching element connected between the first connection terminal of a corresponding one of the three windings and the high potential wire, and the lower reverse conduction switching element being a reverse conduction switching element connected between the first connection terminal of the corresponding one of the three windings and the low potential wire. When external electrical equipment is connected to the port, the control circuit performs a determination process and an output voltage adjustment process. The determination process is a process of determining whether an output voltage of the second battery is higher than an output voltage of the first battery. The output voltage adjustment process is a process of, when determination is made in the determination process that the output voltage of the second battery is higher than the output voltage of the first battery, reducing the output voltage of the second battery to a value lower than the output voltage of the first battery by supplying electric power from the second battery to the electrical equipment with a cathode of the second battery being connected to the high potential connection terminal via the neutral point, at least one of the three windings, at least one of the upper reverse conduction switching elements, and the high potential wire and with an anode of the second battery being connected to the low potential connection terminal.

In the present specification, the “reverse conduction switching element” means an element in which a switching element and a diode are connected in parallel with each other with a cathode of the diode connected to a high potential terminal of the switching element and an anode of the diode connected to a low potential terminal of the switching element. The switching element may be a semiconductor switching element such as a field effect transistor or an insulated gate bipolar transistor. The diode may be a p-n diode, or may be a Schottky barrier diode. The switching element and the diode may be provided on a common semiconductor substrate, or may be provided on separate semiconductor substrates. In the present specification, the reverse conduction switching element being on means that the switching element included in the reverse conduction switching element is on, and the reverse conduction switching element being off means that the switching element included in the reverse conduction switching element is off.

In this electrical circuit, when the output voltage of the second battery is higher than the output voltage of the first battery, the output voltage of the second battery is reduced to a value lower than the output voltage of the first battery by the output voltage adjustment process. This can reduce the possibility of the leakage current when the first battery and the second battery are subsequently connected in parallel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of an electrical circuit (a diagram showing a connection path to a first battery and a second battery);

FIG. 2 is a circuit diagram of an electrical circuit (a diagram showing a path of a leakage current); and

FIG. 3 is a flowchart illustrating a process executed by the control circuit.

### DETAILED DESCRIPTION OF EMBODIMENTS

In an example of the electrical circuit described above, when the output voltage of the second battery drops to a value lower than the output voltage of the first battery in the output voltage adjustment process, the control circuit may transfer electric power between the second battery and the electrical equipment in a state where the cathode of the second battery is connected to the high potential connection terminal via the neutral point, at least one of the windings, the upper reverse conduction switching element, and the high potential wire, and the anode of the second battery is connected to the low potential connection terminal, and may perform a parallel power transfer process of transferring electric power between the first battery and the electrical equipment in a state where the cathode of the first battery is connected to the high potential connection terminal and the anode of the first battery is connected to the low potential connection terminal.

The parallel power transfer process may be a process of supplying electric power from the first battery and the second battery to external electrical equipment (i.e., a process of discharging the first battery and the second battery), or a process of supplying electric power from external electrical equipment to the first battery and the second battery (i.e., a process of charging the first battery and the second battery).

In an example of the electrical circuit described above, the control circuit may start the parallel power transfer process in a state in which the current flowing between the electrical circuit and the electrical equipment is reduced when the output voltage of the second battery drops to a value lower than the output voltage of the first battery in the output voltage adjustment process.

According to this configuration, deterioration of a switch (for example, a relay switch) connecting the first battery to the port can be suppressed.

In the example of the electrical circuit described above, the control circuit may execute the parallel power transfer process when the control circuit determines that the output voltage of the second battery is lower than the output voltage of the first battery in the determination process.

In an example of the electrical circuit described above, the control circuit may execute the parallel power transfer process such that a state in which an output voltage of the second battery is lower than an output voltage of the first battery is maintained.

According to this configuration, it is possible to reduce the possibility of a leakage current during execution of the parallel power transfer process.

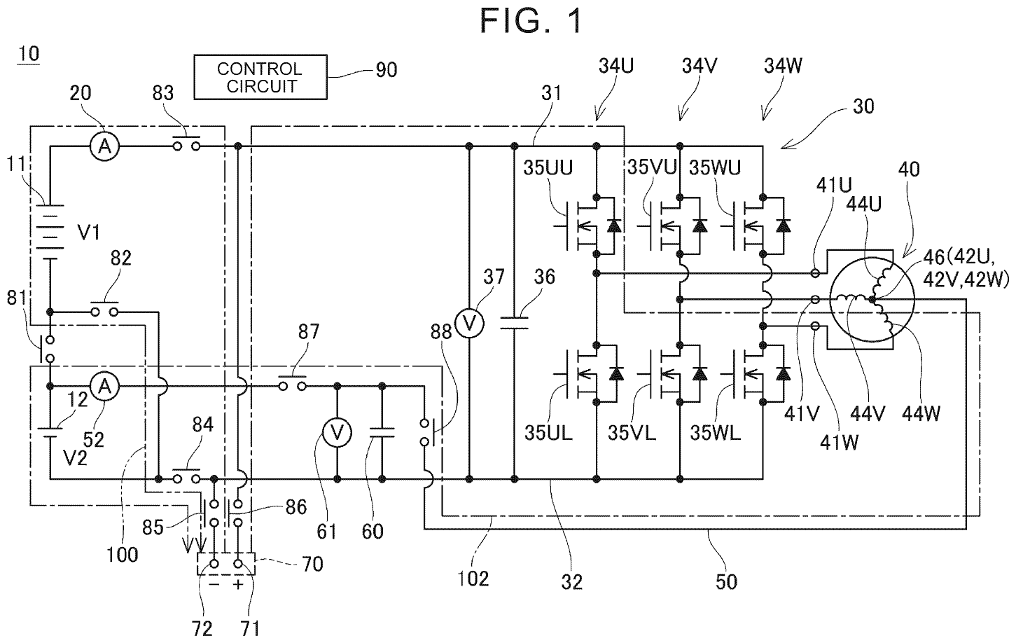

The electrical circuit 10 of the embodiment shown in FIG. 1 is mounted on a vehicle. The electrical circuit 10 includes a first battery 11, a second battery 12, an inverter circuit 30, and a three-phase motor 40. The three-phase motor 40 is a driving motor of the vehicle. The inverter circuit 30 converts the DC power supplied from the first battery 11 and the second battery 12 into AC power and supplies the AC power to the three-phase motor 40. As a result, the three-phase motor 40 rotates the drive wheels, and the vehicle travels.

The three-phase motor 40 has a U-phase winding 44U, a V-phase winding 44V, and a W-phase winding 44W. Terminal 41U and terminal 42U are provided at both ends of the winding 44U. Terminal 41V and terminal 42V are provided at both ends of the winding 44V. Terminal 41W and terminal 42W are provided at both ends of the winding 44W. The terminals 42U, 42V, 42W are connected to each other at a neutral point 46.

The inverter-circuit 30 is connected to the terminal 41U, 41V, 41W of the three-phase motor 40. The inverter circuit 30 includes a high potential wire 31, a low potential wire 32, and three series switch circuits 34U, 34V, 34W. Each of the series switch circuits 34U, 34V, 34W includes two reverse conduction switching elements 35 connected in series between the high potential wire 31 and the low potential wire 32. In the following description, of the two reverse conduction switching elements 35 connected in series, the one connected to the high potential wire 31 is referred to as an upper reverse conduction switching element, and the one connected to the low potential wire 32 is referred to as a lower reverse conduction switching element. The reverse conduction switching element 35 has a configuration in which switching elements (for example, insulated gate bipolar transistors or field-effect transistors) and diodes (for example, p-n diodes or Schottky barrier diodes) are connected in anti-parallel. In each reverse conduction switching element 35, the cathode of the diode is connected to the high potential terminal (i.e., collector or drain) of the switching element and the anode of the diode is connected to the low potential terminal (i.e., emitter or source) of the switching element.

The series switch circuit 34U is provided for the winding 44U. The series switch circuit 34U has an upper reverse conduction switching element 35UU and a lower reverse conduction switching element 35UL. The high potential terminal of the upper reverse conduction switching element 35UU is connected to the high potential wire 31. The low potential terminal of the upper reverse conduction switching element 35UU and the high potential terminal of the lower reverse conduction switching element 35UL are connected to the terminal 41U. The low potential terminal of the lower reverse conduction switching element 35UL is connected to the low potential wire 32.

The series switch circuit 34V is provided for the winding 44V. The series switch circuit 34V has an upper reverse conduction switching element 35VU and a lower reverse conduction switching element 35VL. The high potential terminal of the upper reverse conduction switching element 35VU is connected to the high potential wire 31. The low potential terminal of the upper reverse conduction switching element 35VU and the high potential terminal of the lower reverse conduction switching element 35VL are connected to the terminal 41V. The low potential terminal of the lower reverse conduction switching element 35VL is connected to the low potential wire 32.

The series switch circuit 34W is provided for the winding 44W. The series switch circuit 34W has an upper reverse conduction switching element 35WU and a lower reverse conduction switching element 35WL. The high potential terminal of the upper reverse conduction switching element 35WU is connected to the high potential wire 31. The low potential terminal of the upper reverse conduction switching element 35WU and the high potential terminal of the lower reverse conduction switching element 35WL are connected to the terminal 41W. The low potential terminal of the lower reverse conduction switching element 35WL is connected to the low potential wire 32.

A capacitor 36 is connected between the high potential wire 31 and the low potential wire 32. A voltmeter 37 is connected between the high potential wire 31 and the low potential wire 32.

A neutral point wire 50 is connected to the neutral point 46 of the three-phase motor 40. A capacitor 60 is connected between the neutral point wire 50 and the low potential wire 32. A voltmeter 61 is connected between the neutral point wire 50 and the low potential wire 32.

The electrical circuit 10 has a port 70. A connector of electrical equipment located outside the vehicle (hereinafter referred to as external electrical equipment) can be connected to the port 70. The port 70 has a high potential connection terminal 71 and a low potential connection terminal 72.

The electrical circuit 10 includes a plurality of relay switches 81 to 88. When the relay switches are switched, the connection relationship between the first battery 11, the second battery 12, the high potential wire 31, the low potential wire 32, the neutral point 46, and the port 70 is changed.

The relay switch 81 is provided between the anode of the first battery 11 and the cathode of the second battery 12. When the relay switch 81 is turned on, the first battery 11 and the second battery 12 are connected in series.

The relay switch 82 is provided between the anode of the first battery 11 and the anode of the second battery 12. When the relay switch 82 is turned on, the anode of the first battery 11 and the anode of the second battery 12 are connected.

An ammeter 20 and a relay switch 83 are provided in series between the cathode of the first battery 11 and the high potential wire 31. When the relay switch 83 is turned on, the cathode of the first battery 11 is connected to the high potential wire 31.

The relay switch 84 is provided between the anode of the second battery 12 and the low potential wire 32. When the relay switch 84 is turned on, the anode of the second battery 12 is connected to the low potential wire 32.

The relay switch 85 is provided between the low potential connection terminal 72 and the low potential wire 32. When the relay switch 85 is turned on, the low potential connection terminal 72 is connected to the low potential wire 32.

The relay switch 86 is provided between the high potential connection terminal 71 and the high potential wire 31. When the relay switch 86 is turned on, the high potential connection terminal 71 is connected to the high potential wire 31.

An ammeter 52 and a relay switch 87 are provided in series between the cathode of the second battery 12 and the neutral point wire 50. Further, a relay switch 88 is provided in the neutral point wire 50. When the relay switches 87 and 88 are turned on, the cathode of the second battery 12 is connected to the neutral point 46.

The electrical circuit 10 includes a control circuit 90. The control circuit 90 includes CPU, memories, and the like. A program for controlling the electrical circuit 10 is stored in the memory of the control circuit 90. The memory is an example of a storage medium. The control circuit 90 controls the switching elements of the reverse conduction switching elements 35 and the relay switches 81 to 88 in accordance with the program. In addition, the control circuit 90 can communicate with the external electrical equipment when the external electrical equipment is connected to the port 70.

The control circuit 90 can perform a normal operation of driving the three-phase motor 40. In normal operation, the control circuit 90 turns on the relay switches 81, 83, and 84 and turns off the relay switches 82, 85, 86, 87, and 88. In this state, the first battery 11 and the second battery 12 are connected in series between the high potential wire 31 and the low potential wire 32. Therefore, the DC voltage output from the series circuit of the first battery 11 and the second battery 12 is applied between the high potential wire 31 and the low potential wire 32. The control circuit 90 switches the switching elements of the reverse conduction switching elements 35 to convert the DC power applied between the high potential wire 31 and the low potential wire 32 into AC power, and supplies the AC power to the three-phase motor 40. This causes the three-phase motor 40 to rotate. The control circuit 90 controls the torque and the rotation speed of the three-phase motor 40 by changing the amplitude, frequency, and the like of the alternating current supplied to the three-phase motor 40.

As described above, the external electrical equipment is connected to the port 70. The control circuit 90 can perform a power transfer process of transferring electric power between the electrical circuit 10 and the external electrical equipment in a state where the external electrical equipment is connected to the port 70.

When power is transferred between the first battery 11 and the external electrical equipment, the control circuit 90 forms a connection path indicated by an arrow 100 in FIG. 1. That is, the control circuit 90 turns on the relay switches 82, 83, 84, 85, and 86 and turns off the relay switch 81. In this state, the cathode of the first battery 11 is connected to the high potential connection terminal 71 of the port 70 via the relay switches 83 and 86. The anode of the first battery 11 is connected to the low potential connection terminal 72 of the port 70 via the relay switches 82, 84, and 85. In this state, when a voltage is applied to the port 70 in a direction in which the high potential connection terminal 71 becomes a higher potential than the low potential connection terminal 72 by the external electrical equipment, a current flows in a path indicated by an arrow 100, and the first battery 11 is charged. That is, the first battery charging process is executed. When the external electrical equipment connects the device between the high potential connection terminal 71 and the low potential connection terminal 72 in a state where the first battery 11 is connected to the external electrical equipment, a current flows in a direction opposite to the direction indicated by the arrow 100, and electric power is supplied from the first battery 11 to the external electrical equipment. That is, the first battery power supply process is executed.

When power is transferred between the second battery 12 and the external electrical equipment, the control circuit 90 forms a connection path indicated by an arrow 102 in FIG. 1. That is, the control circuit 90 turns on the relay switches 84, 85, 86, 87, and 88 and turns off the relay switch 81. Further, the control circuit 90 turns off the lower reverse conduction switching element 35UL, 35VL, 35WL and turns on at least one of the upper reverse conduction switching elements 35UU, 35VU, 35WU. Note that the arrow 102 exemplifies a path when the upper reverse conduction switching element 35VU is turned on. In this condition, the cathode of the second battery 12 is connected to the high potential connection terminal 71 of the port 70 via the relay switches 87 and 88, the neutral point 46, the winding 44V, the upper reverse conduction switching element 35VU, and the relay switch 86. The anode of the second battery 12 is connected to the low potential connection terminal 72 of the port 70 via the relay switches 84 and 85. In this state, when a voltage is applied to the port 70 in a direction in which the high potential connection terminal 71 becomes higher than the low potential connection terminal 72 by the external electrical equipment, a current flows in a path indicated by an arrow 102, and the second battery 12 is charged. That is, the second battery charging process is executed. When the second battery 12 is charged, the upper reverse conduction switching element may be periodically switched. In this case, the winding of the inverter circuit 30 and the three-phase motor 40 operates as a step-down converter circuit, and the charging current for the second battery 12 can be suppressed. Further, when the external electrical equipment connects the device between the high potential connection terminal 71 and the low potential connection terminal 72 in a state where the second battery 12 is connected to the external electrical equipment, a current flows in a direction opposite to the arrow 102, and electric power is supplied from the second battery 12 to the external electrical equipment. That is, the second battery power supply process is executed. In the second battery power supply process, a current flows through the diode of the upper reverse conduction switching element, so that the switching element of the upper reverse conduction switching element may be turned off.

As described above, the power transfer process includes a first battery charging process, a first battery power supply process, a second battery charging process, and a second battery power supply process.

In addition, the control circuit 90 may connect the first battery 11 and the second battery 12 to the port 70 in parallel through the paths indicated by the arrows 100 and 102. When the first battery 11 and the second battery 12 are connected to the port 70 in parallel, a process of simultaneously executing the first battery charging process and the second battery charging process (hereinafter, referred to as parallel charging process) can be performed, and a process of simultaneously executing the first battery power supply process and the second battery power supply process (hereinafter, referred to as parallel power supply process) can be performed. In addition, the control circuit 90 can perform a process of selectively executing the parallel charging process and the parallel power feeding process (hereinafter, referred to as a parallel power feeding process) according to the situation in a state in which the first battery 11 and the second battery 12 are connected to the port 70 in parallel.

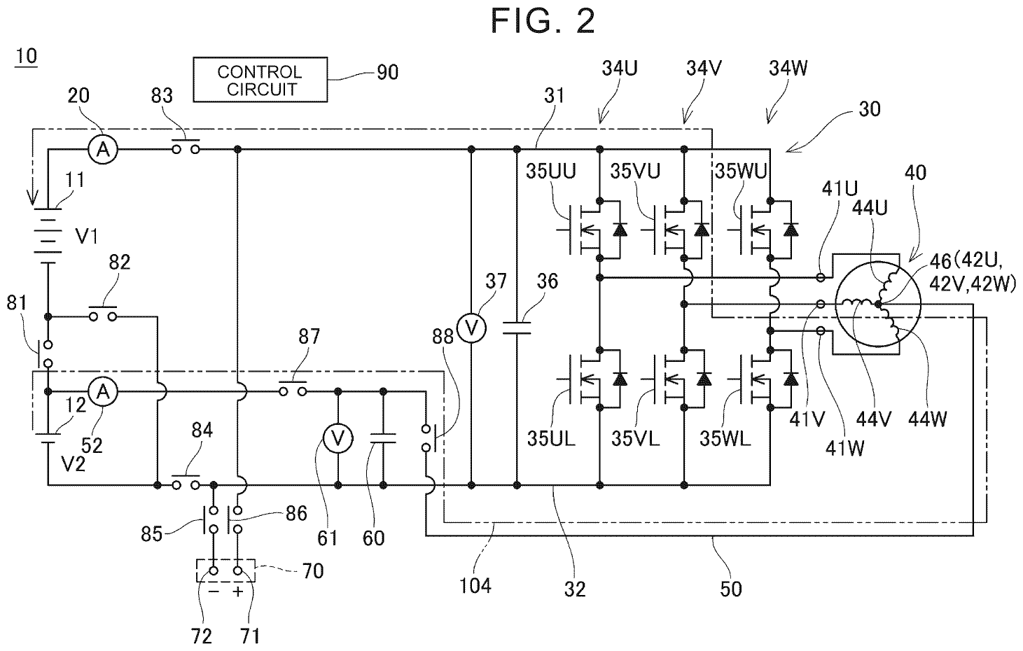

When the first battery 11 and the second battery 12 are connected in parallel with the output voltage V2 of the second battery 12 being higher than the output voltage V1 of the first battery 11, a leakage current flows from the second battery 12 to the first battery 11 through a path indicated by an arrow 104 in FIG. 2. That is, when the output voltage V2 of the second battery 12 is higher than the output voltage V1 of the first battery 11, a voltage is applied forward to the diodes of the upper reverse conduction switching element 35UU, 35VU, 35WU, and thus these diodes are turned on. Therefore, a leakage current flows from the cathode of the second battery 12 to the cathode of the first battery 11 via the relay switches 87 and 88, the neutral point 46, the winding 44U, 44V, 44W, the diodes of the upper reverse conduction switching element 35UU, 35VU, 35WU, and the relay switch 83. Note that the arrow 104 exemplifies a path through the diode of the upper reverse conduction switching element 35VU. Since there is no load consuming power on the path through which the leakage current flows, the leakage current becomes a relatively large current. Therefore, the leakage current degrades the first battery 11 and the second battery 12.

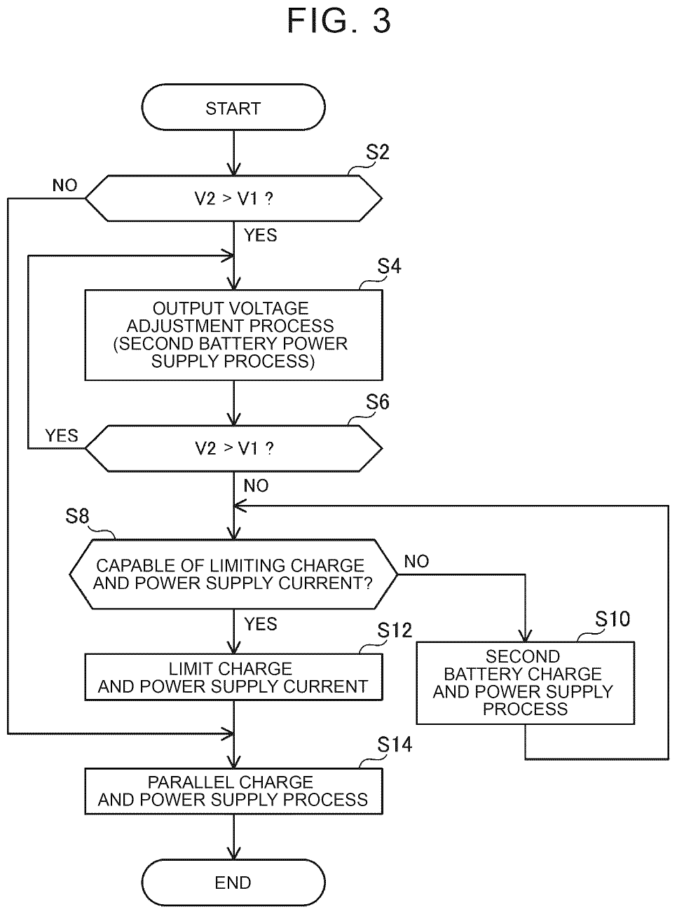

The control circuit 90 executes the process illustrated in FIG. 3 in order to execute the power transfer process while reducing the possibility of the leakage current. When the external electrical equipment is connected to the port 70, the control circuit 90 executes the processing illustrated in FIG. 3 in accordance with the program stored in the memory. At the start of the process of FIG. 3, the vehicle is stopped and the relay switches 81 to 88 and all the reverse conduction switching elements 35 are off. In S2, the control circuit 90 detects the output voltage V1 of the first battery 11 and the output voltage V2 of the second battery 12. For example, the control circuit 90 may turn on the relay switches 82, 83, and 84 and detect the output voltage V1 of the first battery 11 by the voltmeter 37. Further, for example, the control circuit 90 may turn on the relay switches 84 and 87, and detect the output voltage V2 of the second battery 12 by the voltmeter 61. In S2, no current flows through the batteries 11 and 12. Therefore, the output-voltage V1, V2 detected by S2 is Open Circuit Voltage (OCV). The control circuit 90 determines whether or not the output voltage V2 is higher than the output voltage V1.

When the output voltage V2 is equal to or lower than the output voltage V1 (that is, when S2 is NO), the control circuit 90 executes the parallel charge/power supply process in S14. When the output-voltage V2 is equal to or lower than the output-voltage V1, no leakage current is generated even if the first battery 11 and the second battery 12 are connected in parallel, so that the parallel charge/power supply process can be appropriately performed in S14.

When the output voltage V2 is higher than the output voltage V1 (that is, when S2 is YES), the control circuit 90 executes the second battery power supply process in S4. That is, the control circuit 90 connects the second battery 12 to the port 70 through the path indicated by the arrow 102 in FIG. 1, and instructs the external electrical equipment to perform the power supply operation. Therefore, a current flows in the opposite direction of the arrow 102 in FIG. 1, and electric power is supplied from the second battery 12 to the external electrical equipment. In this way, in S4, the second battery 12 is discharged, so that the output-voltage V2 of the second battery 12 gradually decreases. In S4, the control circuit 90 shuts off the first battery 11 from the port 70 by turning off the relay switches 82 and 83. Therefore, in S4, the output-voltage V1 of the first battery 11 does not change.

After S4 is performed for a predetermined period, the control circuit 90 executes S6. In S6, the control circuit 90 determines whether or not the output voltage V2 is higher than the output voltage V1. Since the output voltage V1 of the first battery 11 does not change in S4 as described above, the output voltage V1 measured in S6 by S2 can be used as a comparative value. In addition, the control circuit 90 measures the output-voltage V2 in S6. Here, the control circuit 90 may measure the output voltage V2 (i.e., Closed Circuit Voltage (CCV) while a current is flowing through the second battery 12, or may measure the output voltage V2 (i.e., OCV) by stopping the current in the second battery 12. The control circuit 90 repeats S4, S6 until the output voltage V2 becomes equal to or lower than the output voltage V1. While S4, S6 is repeated, the output voltage V2 decreases until the output voltage V1 or less. As described above, S4, S6 adjusts the output voltage V2 so that the output voltage V2 becomes equal to or lower than the output voltage V1. When the output voltage V2 becomes equal to or lower than the output voltage V1, the control circuit 90 determines NO in S6 and executes S8.

In S8, the control circuit 90 determines whether the charge and power supply current (i.e., the current flowing between the electrical circuit 10 and the external electrical equipment via the port 70) can be limited by the external electrical equipment. That is, the control circuit 90 determines whether or not the charge and power supply current can be reduced from the current value. This determination is made based on the type of the external electrical equipment, the operating state of the external electrical equipment, and the like. When the charge and power supply current cannot be limited, the control circuit 90 executes the charge and power supply process using the second battery 12 in S10. That is, the control circuit 90 selectively executes the second battery charging process and the second battery power supply process. Further, in S10, the control circuit 90 turns off the relay switches 82 and 83, and shuts off the first battery 11 from the port 70. The control circuit 90 repeats S8, S10 until the charge and power supply current can be limited by the external electrical equipment. When the charge and power supply current cannot be limited by the external electrical equipment, S8, S10 is continued until the completion of the power transfer process.

When the charge and power supply current can be limited by the external electrical equipment, the control circuit 90 determines YES in S8 and executes S12. In S12, the control circuit 90 commands the external electrical equipment to limit the charge supply current. Thereafter, the control circuit 90 turns on the relay switches 82 and 83, thereby starting S14 parallel charging and feeding process. As described above, since the control circuit 90 turns on the relay switches 82 and 83 in a state where the charge and power supply current is reduced, a high inrush current is less likely to flow through the relay switches 82 and 83. Thus, the relay switches 82, 83 are less likely to be fixed. When S14 is started, the control circuit 90 releases the limit of the charge and power supply current. As a result, the parallel charge and power supply process can be executed with a high charge and power supply current.

In S14 parallel charge and power supply operation, the control circuit 90 controls the current flowing through the respective batteries so that the output voltage V1 is maintained higher than the output voltage V2. For example, when the output voltage V2 rises to a value close to the output voltage V1, the control circuit 90 periodically switches the upper reverse conduction switching element 35UU, 35VU, 35WU to limit the charge current to the second battery 12. As a result, the output voltage V2 is less likely to become higher than the output voltage V1. As a result, a leakage current is less likely to flow during S14.

As described above, according to the electrical circuit 10 of the embodiment, it is possible to execute the power transfer process while reducing the possibility of the leakage current.

In the embodiment, the second battery charge/power supply process is executed in S10, but only one of the second battery charge process and the second battery power supply process may be executed.

S14 of the embodiment is an exemplary parallel power transfer process. In the embodiment, the parallel charge/power supply process is executed as the parallel power transfer process, but only one of the parallel charge process and the parallel power supply process may be executed as the parallel power transfer process.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. An electrical circuit mounted on a vehicle, the electrical circuit comprising:
a first battery;
a second battery;
a three-phase motor including three windings that are a U-phase winding, a V-phase winding, and a W-phase winding, each of the three windings including a first connection terminal provided at one end of the winding and a second connection terminal provided at the other end of the winding, and the second connection terminals of the three windings being connected to each other at a neutral point;
an inverter circuit connected to the first connection terminal of the U-phase winding, the first connection terminal of the V-phase winding, and the first connection terminal of the W-phase winding;
a port including a high potential connection terminal and a low potential connection terminal; and
a control circuit, wherein
the inverter circuit includes a high potential wire, a low potential wire, and three series switch circuits provided for each of the three windings,
each of the series switch circuits includes an upper reverse conduction switching element and a lower reverse conduction switching element, the upper reverse conduction switching element being a reverse conduction switching element connected between the first connection terminal of a corresponding one of the three windings and the high potential wire, and the lower reverse conduction switching element being a reverse conduction switching element connected between the first connection terminal of the corresponding one of the three windings and the low potential wire,
when external electrical equipment is connected to the port, the control circuit performs a determination process of determining whether an output voltage of the second battery is higher than an output voltage of the first battery, and
when determination is made in the determination process that the output voltage of the second battery is higher than the output voltage of the first battery, the control circuit performs an output voltage adjustment process, the output voltage adjustment process being a process of reducing the output voltage of the second battery to a value lower than the output voltage of the first battery by supplying electric power from the second battery to the electrical equipment with a cathode of the second battery being connected to the high potential connection terminal via the neutral point, at least one of the three windings, at least one of the upper reverse conduction switching elements, and the high potential wire and with an anode of the second battery being connected to the low potential connection terminal.

2. The electrical circuit according to claim 1, wherein when the output voltage of the second battery is reduced to a value lower than the output voltage of the first battery in the output voltage adjustment process, the control circuit performs a parallel power transfer process, the parallel power transfer process being a process of transferring electric power between the second battery and the electrical equipment with the cathode of the second battery being connected to the high potential connection terminal via the neutral point, the at least one of the three windings, the at least one of the upper reverse conduction switching elements, and the high potential wire and with the anode of the second battery being connected to the low potential connection terminal, and transferring electric power between the first battery and the electrical equipment with a cathode of the first battery being connected to the high potential connection terminal and with an anode of the first battery being connected to the low potential connection terminal.

3. The electrical circuit according to claim 2, wherein when the output voltage of the second battery is reduced to a value lower than the output voltage of the first battery in the output voltage adjustment process, the control circuit starts the parallel power transfer process with a current between the electrical circuit and the electrical equipment being reduced.

4. The electrical circuit according to claim 2, wherein the control circuit performs the parallel power transfer process when determination is made in the determination process that the output voltage of the second battery is lower than the output voltage of the first battery.

5. The electrical circuit according to claim 2, wherein the control circuit performs the parallel power transfer process in such a manner that the output voltage of the second battery is kept lower than the output voltage of the first battery.

6. A non-transitory storage medium storing a program that is executed by an electrical circuit mounted on a vehicle, wherein
the electrical circuit includes
a first battery,
a second battery,
a three-phase motor including three windings that are a U-phase winding, a V-phase winding, and a W-phase winding, each of the three windings including a first connection terminal provided at one end of the winding and a second connection terminal provided at the other end of the winding, and the second connection terminals of the three windings being connected to each other at a neutral point,
an inverter circuit connected to the first connection terminal of the U-phase winding, the first connection terminal of the V-phase winding, and the first connection terminal of the W-phase winding,
a port including a high potential connection terminal and a low potential connection terminal, and
a control circuit,
the inverter circuit includes a high potential wire, a low potential wire, and three series switch circuits provided for each of the three windings,
each of the series switch circuits includes an upper reverse conduction switching element and a lower reverse conduction switching element, the upper reverse conduction switching element being a reverse conduction switching element connected between the first connection terminal of a corresponding one of the three windings and the high potential wire, and the lower reverse conduction switching element being a reverse conduction switching element connected between the first connection terminal of the corresponding one of the three windings and the low potential wire,
when external electrical equipment is connected to the port, the program causes the control circuit to perform a determination process of determining whether an output voltage of the second battery is higher than an output voltage of the first battery, and
when determination is made in the determination process that the output voltage of the second battery is higher than the output voltage of the first battery, the program causes the control circuit to perform an output voltage adjustment process, the output voltage adjustment process being a process of reducing the output voltage of the second battery to a value lower than the output voltage of the first battery by supplying electric power from the second battery to the electrical equipment with a cathode of the second battery being connected to the high potential connection terminal via the neutral point, at least one of the three windings, at least one of the upper reverse conduction switching elements, and the high potential wire and with an anode of the second battery being connected to the low potential connection terminal.
